(19) United States
(12) Patent Application Publication
(10) Pub. No.: US 2006/0162401 A1
(43) Pub. Date: Jul. 27, 2006

(54) Security cover for hasp bolt(s)

(76) Inventors: Ming Liang Shiao, Anaheim, CA (US); Franklin Minnella, Murietta, CA (US)

Correspondence Address: David L. Bell, Esq., Suite B-507, 2110 Artesia Blvd., Redondo Beach, CA, 90278, US

(21) Appl. No.: 11/040,377

(22) Filed: Jan. 21, 2005

(51) Int. Cl. E05B 67/38

(52) U.S. Cl. 70/56

(57) ABSTRACT

A security cover for hasp bolts to protect said bolts from attack by drilling, filing or other vandalism by means of an enclosure over the bolt heads. Said hasp bolt cover itself is designed such that the cover is secured from within and is therefore resistant to drilling, prying, blunt force assault or other means of attack.

### BACKGROUND OF THE INVENTION

1. Field of the Invention

The present invention relates generally to padlocks and means to make them more secure. The particular methods and apparatus described relate to the protection of bolts used to secure the lock hasp to the object that is to be secured. However, the invention as described more fully detailed below is not limited to this particular application or use and the invention is not intended to be limited to this particular use.

2. Description of the Related Art

A man was purportedly asked why he robbed banks. His reply was direct, “because that is where the money is”. For much the same reason, machines used in the vending machine industry have been under constant attack for theft and vandalism. First, the machines were padlocked. The locks were easy to break so the venders used stronger locks. When the locks became too hard to easily break, the thieves began attacking other parts of the lock assembly, such as the shackles. The vendors began positioning the shackles so that they could not be easily broken. So the thieves next began attacking the hasps. Now, designs have been developed to protect the hasps and the thieves and vandals have begun attacking the bolts that attach the hasps to the vending machine. The hasp bolts may be drilled out, ground out or disabled by any other of a variety of methods. Simply protecting the bolts from attack can negate many of these attacks in a cost-effective manner.

Several inventors have approached the problem of protecting the locking mechanism and/or the hasp. U.S. Pat. No. 6,735,989 (the “989” patent) issued to Schramm, et al. on May 18, 2004 for a “Pilfer and vandalism resistant hasp locking mechanism”. That invention protects the hasp by providing a complicated series of cover plates assembled in a precise fashion and includes a hasp key. The “989” patent includes an excellent discussion of the nature of vandalism attacks on vending machines, in particular, and explains that the same attacks are used against other enclosures that need to be secured. The problem with the “989” invention is that is requires a specific type of hasp, is complicated (making it more expensive) and is not universally applicable to hasps used in protecting enclosures.

U.S. Pat. No. 5,172,574 (the “574” patent) issued to Perfetto on Dec. 22, 1992 attacks the hasp protection problem by applying a heavy steel bar over the hasp. The steel bar is designed to protect not only the hasp, but also a specific type of lock that is used with the device. This invention is much simpler than the “989” patent, but still fails to protect a wide variety of lock styles used in the applicable industry.

The present invention addresses the problem of protecting a hasp that may be found in a variety of configurations and doing so in a manner that is simple, inexpensive and effective.

Therefore, the goal of the present invention is to protect a lock hasp from vandalism by an attack on the bolts that secure the hasp to an enclosure and to do so in an economic and efficient manner.

### SUMMARY OF THE INVENTION

It is an object of the present invention to protect a lock hasp from vandalism from an attack on the bolts that secure the hasp to an enclosure and to protect the lock hasp from vandalism in a manner that is cheaper and better than currently existing technology.

In accordance with these objects and with others which will be described and which will become apparent, an exemplary embodiment of hasp bolt security cover in accordance with the present invention comprises device that contains a shielded cover that is capable of laying flat against the surface of the hasp while having a raised surface to accommodate the height of the normal bolt head used in securing the hasp to the enclosure being locked. While the most commonly used application will be the protection of vending machines, the invention may be used on any enclosure that requires a padlock using a hasp. Thus, both vending machines and other enclosures will simply be referred to as “enclosures”.

In the preferred embodiment of the invention, the hasp bolt security cover includes a roughly semicircular cylinder with a flat bottom. The rectangular shaped bottom surface has a t-shaped cutout with the horizontal portion of the “t” being long enough to accommodate the length between the bolts used in hasps commonly used in the industry. By way of example, in some machines, the bolts may be one inch apart while in others the bolts may be two inches apart. An important feature of this invention is that it accommodates many of the different widths between bolts that are used for various types of enclosures. The width of the cutout is wide enough to allow the insertion of bolts most commonly used in the industry to secure hasps to the enclosure to be locked. The opposing shorter two sides of the rectangular bottom surface form ends that bend towards and meet the upper, semi-cylindrical portion of the cover. The semi-cylindrical portion of the cover and the rectangular bottom surface are securely affixed to each other through welding or other means. The bolts being protected are long enough such that the bolt head fits securely within the cover while the shank of the bolt passes through the t-shaped cutout of the bottom surface of the cover, the thickness of the hasp bar and the thickness of the enclosure wall while still leaving enough room to firmly attach at least one nut onto the bolt shank when the shank passes through the enclosure wall and into the interior of the enclosure.

The hasp bolt security cover is attached to the enclosure while the hasp is loosely attached to the enclosure via the hasp bolts and with access available to the interior of the enclosure. Assuming two bolts used to secure the hasp, the vertical portion of the t-shaped cutout slides over the first hasp bolt head. The hasp bolt security cover is moved until the hasp bolt head is at the intersection of the vertical and horizontal portions of the t-shaped cutout. The hasp bolt security cover is then moved such that the hasp bolt head is positioned at one end of the horizontal portion of the t-shaped cutout. The hasp bolt security cover is then moved such that the vertical portion of the t-shape cutout slides over the remaining hasp bolt head, up the vertical portion of the cutout and to the opposing end of the horizontal portion of the t-shape cutout.

By using a t-shape, the hasp bolt security cover can accommodate hasp bolts that are varying distances away from each other. The hasp bolt security cover will accommodate hasp bolts having a maximum distance apart that is the length of the horizontal portion of the t-shape while the minimum distance will be something smaller than twice the diameter of the hasp bolts being used.

While the preferred embodiment of the invention includes a t-shaped cutout, the cutout need not necessarily be of that shape to be envisioned within the invention. Other shapes may be used to accommodate differing configurations of hasp bolts used for a lock hasp. By virtue of this invention a simple hasp bolt security cover protects a variety of configurations of hasp bolt heads from attack by drilling, grinding, or other means hasp bolt security cover that would otherwise render the entire locking mechanism ineffective to securing the enclosure.

### BRIEF DESCRIPTION OF THE DRAWINGS

For a further understanding of the objects and advantages of the present invention, reference should be had to the following detailed description, taken in conjunction with the accompanying drawing, in which like parts are given like reference numbers and wherein:

FIG. 1 shows the different components of the invention in the preferred embodiment including the hasp, the hasp bolts and the hasp bolt security cover;

FIG. 2 shows an enclosure with the hasp affixed to it;

FIG. 3a shows the side elevation of hasp bolt security cover top portion;

FIG. 3b shows the front elevation of the hasp bolt security cover top portion with a mushroom shaped cutout;

FIG. 4 shows the bottom elevation of the hasp bolt security cover, the hasp bolt security cover base unit, showing the bottom surface and including the t-shaped cutout;

FIG. 5 shows the hasp bolt security cover as it is affixed to the hasp bolt base unit.

### DESCRIPTION OF THE PREFERRED EMBODIMENTS

A hasp bolt security cover is described. In the following description, for the purposes of explanation, specific component arrangements and constructions and other details are set forth in order to provide a more thorough understanding of the present invention. It will be apparent to those skilled in the art, however, that the present invention may be practiced without these specific details. In other instances, well known manufacturing methods and structures have not been described in detail so as to refrain from obscuring the present invention unnecessarily.

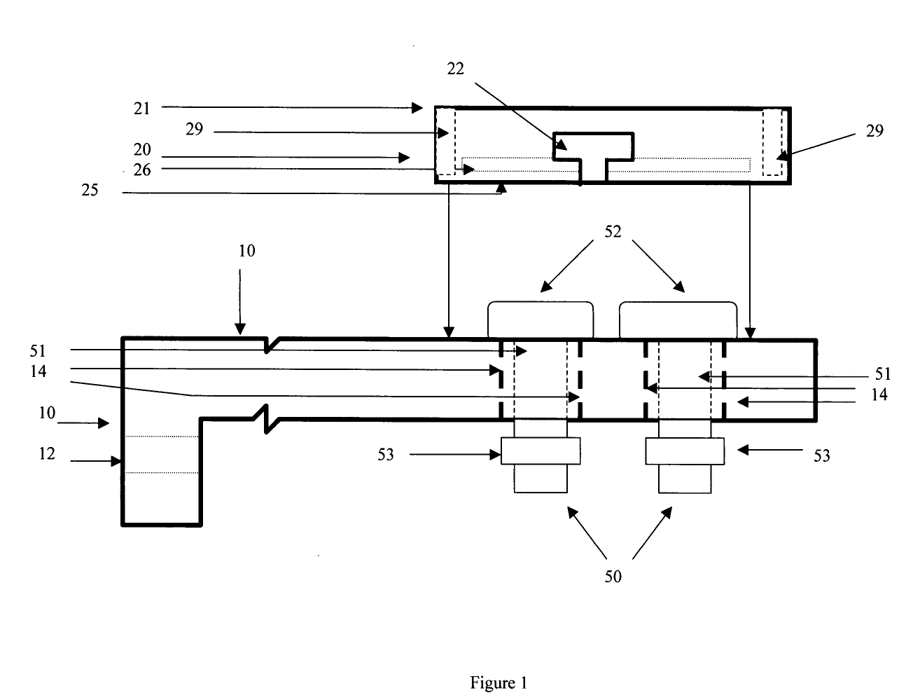

Referring first to FIG. 1, the invention comprises several basic components including a hasp 10, a Hasp bolt security cover 20, a hasp bolt 50 and hasp bolt nut 54. The hasp 10 attaches to the enclosure to be secured (not shown in FIG. 1) by way of hasp bolt(s) 14. The hasp bolt security cover 20 is made of a hardened metal and is affixed to the hasp bolt heads 52 in a manner that will be described in detail below.

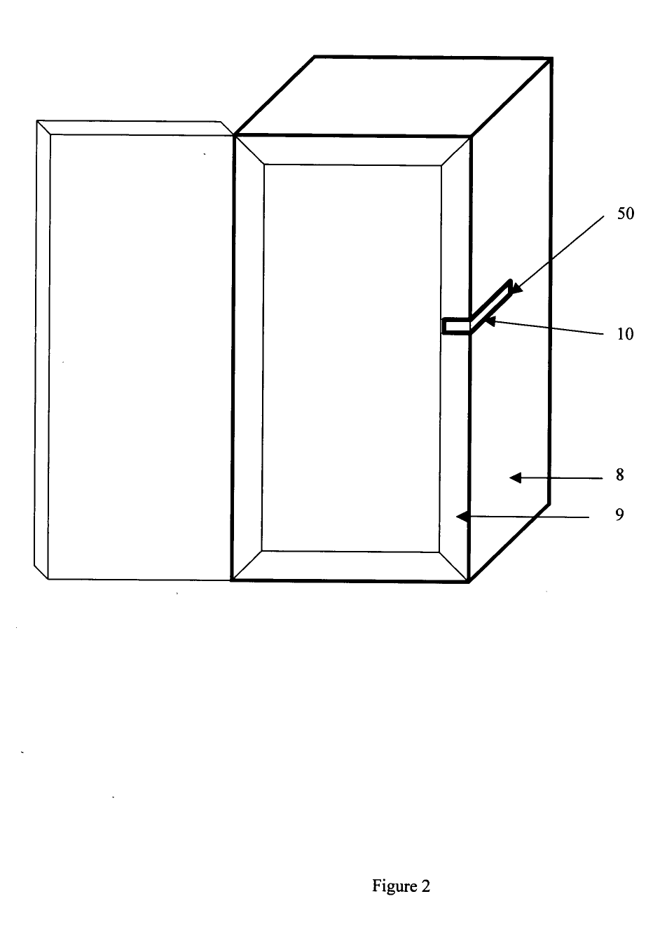

Referring next to FIG. 2, the hasp 10 is affixed to the exterior surface of an enclosure 8. In the preferred embodiment, the enclosure 8 will be a vending machine. However, the enclosure 8 represents any enclosed object whose contents need to be secured. The hasp is secured by way of hasp bolts 50 having the bolt head (not detailed) outside of the enclosure 8, the bolt shank (not detailed) running through the hasp bolt cutout 12 and the enclosure wall 9 and into the interior portion of the enclosure 8.

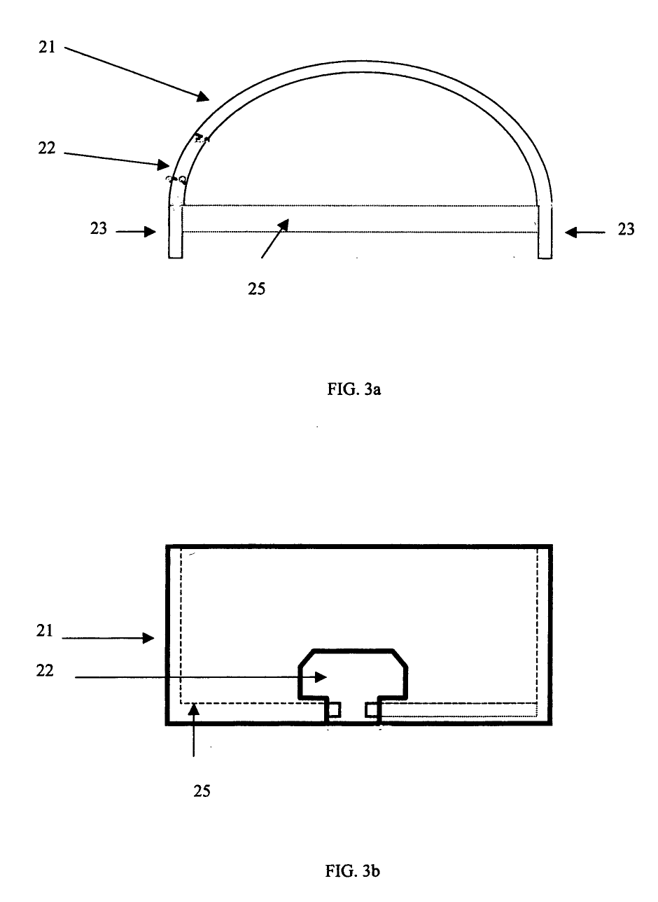

Referring next to FIG. 3a, a side elevation of the top portion 21 of the hasp bolt security cover 20 is shown. The top portion 21 of the hasp bolt security cover 20 is semi-cylindrical in shape and has a hollow interior. The sides 23 of the hasp bolt security cover 20 extend beyond the bottom surface of the hasp bolt security cover base unit 25 (shown in dashed lines) so that when the hasp bolt security cover 20 is in place, the sides 23 of the hasp bolt security cover 20 overlap the sides of the hasp 10 (not shown in FIG. 3a). Referring next to FIG. 3b, a front elevation of the hasp bolt security cover 20 is shown. The front side surface includes a mushroom shaped cutout 22 that allows the hasp bolt head 52 (not shown) and the hasp bolt shank 51 (not shown) to pass through the mushroom shaped cutout 22. The bottom surface of the hasp bolt security cover base unit 25 is shown in dashed lines where it is behind the top portion 21 of the hasp bolt security cover 20 and in solid lines where it extends beyond the mushroom shaped cutout 22.

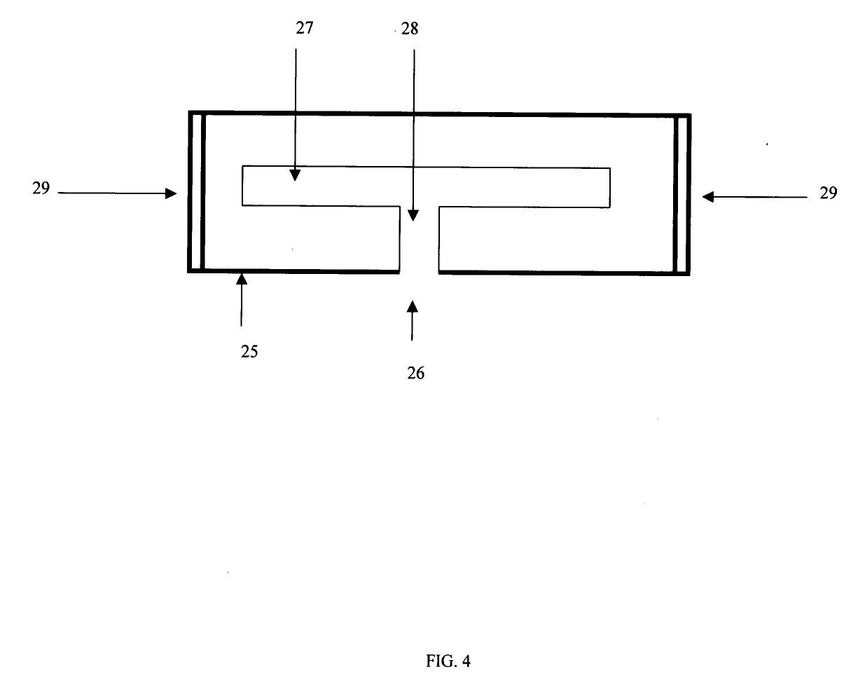

Referring next to FIG. 4, a top elevation of the hasp bolt security cover base unit 25 is shown. The base unit 25 is roughly rectangular in shape and includes a t-shaped cutout 26. The t-shaped cutout 26 contains a horizontal portion 27 and a vertical portion 28. The ends 29 of the base unit 25 are bent upwards to affix to the top portion 21 of the hasp bolt security cover 20 and cover the end space of the top portion 21 of the hasp bolt security cover 20. The shape of the ends 29 of the base unit 25 conforms to the curvature of the top portion 21 of the hasp bolt security cover 20 so that no gap exists between the base unit 25 and the top portion 21 of the hasp bolt security cover 20 when the two are permanently affixed together. The width of the hasp bolt security cover base unit 25 is the same size as, or slightly larger than, the width of the hasp 10.

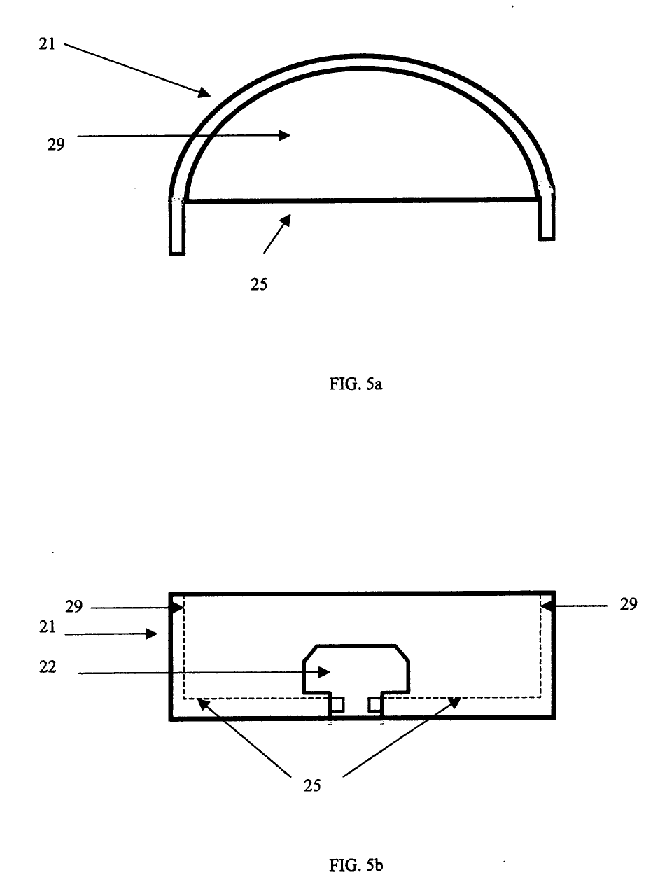

Referring next to FIG. 5 (a & b), the top portion 21 of the hasp bolt security is permanently affixed to the hasp bolt security cover base unit 25 by means of welding or by other means the ensures a permanent and sealed attachment of one unit to the other. FIG. 5a shows a side view of the hasp bolt security cover while FIG. 5b shows a front view.

Finally, FIG. 6 shows the hasp bolt security cover 20 as it is affixed to the hasp 10. As shown in FIG. 2, the hasp 10 is affixed to an enclosure 8 by means of hasp bolt(s) 50. The hasp bolt shank 51 enters into and through the hasp bolt cutout 12, and through the enclosure wall 9. The hasp bolt nut 53 is loosely affixed to the hasp bolt shank 51. Then, the hasp bolt security cover 20 is affixed onto the hasp 10 such as to securely cover the hasp bolt head(s) 52 in the manner further described herein.

Referring now also to FIG. 4, after the hasp bolt nut 53 is loosely affixed to the hasp bolt shank 51, enough space must be left on the bolt shank 51 at the head portion of the bolt 50, such that the vertical portion 28 of the base unit t-shaped cutout 26 can pass around the bolt shank 5 1 and between the hasp 10 and the bolt head 52. The hasp bolt security cover 20 continues to be moved along the direction of the vertical portion 28 of the t-shaped cutout 26 until the bolt shank 51 reaches the intersection of the horizontal portion 27 and the vertical portion 28 of the t-shaped cutout 26. The hasp bolt security cover 20 is then moved such that the bolt shank 51 is positioned along the horizontal portion 27 of the t-shaped cutout 26 far enough so that the vertical portion 28 of the t-shaped cutout 26 can be positioned to accept the next hasp bolt 50 to be secured. This second hasp bolt 50 is affixed to the hasp bolt security cover 20 in the same manner as the first.

After all of the hasp bolts are covered by the hasp bolt security cover 20, all hasp bolt nuts 53 may be tightened so that the hasp bolts are securely affixed to the enclosure wall 9. By tightening said bolts, the hasp bolt security cover 20 is securely affixed to and overlapping the hasp 20.

While the foregoing detailed description has described several embodiments of a motion sensitive switch in accordance with the present invention, the above description is illustrative only and not limiting of the disclosed invention. Indeed, it will be appreciated that the embodiments discussed above and the virtually infinite embodiments that are not mentioned could easily be within the scope and spirit of the present invention. Thus, the present invention is limited only by the claims set forth below.

1. A hasp cover to protect a lock that includes a hasp, said hasp cover comprising,
a top and a bottom, said top having a semi-cylindrical tube shape such that a hollow space is created within the interior of said bolt head cover, sides of sufficient length to overlap both of said bottom and said hasp when said hasp is fully engaged and in place, and said top hollow space is sufficient to allow for full clearance of bolt heads when said bolts heads are fitted within said top interior hollow space, and
said top having a bottom edge that is designed to affix to and cooperate with a hasp cover base unit, and
an opening of sufficient height and width such as to allow a bolt head to enter into said top hollow space through said opening; and
said hasp cover bottom having a top, a bottom and a perimeter,
said hasp-cover bottom also being roughly rectangular in shape such as to match the shape and size of said bottom edge perimeter of said bolt head cover base unit top such that said hasp-cover bottom and said hasp-cover top, when joined, cooperate with each other to form a sealed unit,
said hasp-cover bottom further comprising a plurality of upturned edges at a plurality of ends of said bottom with said upturned edges shaped to form sides of said bolt head cover when said bottom top and said bottom are joined to form said hasp-cover,
said hasp-cover bottom having a t-shaped cutout capable of receiving a shank of a hasp bolt; and
said top and said hasp-cover bottom are permanently affixed to each other,
whereby when said hasp is partially bolted onto an enclosure, and a plurality of hasp bolt shanks are slid through said t-shaped cutout and the hasp bolts of said shanks are tightened securely into place, said hasp cover forms a secure and protective barrier that deters attack on said hasp bolts.

2. The hasp cover of claim one (1) wherein said hasp and said hasp cover are made of metal

3. The hasp cover of claim one (1) wherein said hasp begins at a proximal end in a straight and relatively flat bar, then extends upwards at an angle, then bends to a line roughly parallel to said proximal end of said hasp and continues straight again until turning upwards near a distal end of said hasp and terminating beyond a shackle aperture.

4. The hasp cover of claim one (1) wherein said hasp is roughly rectangular in shape, having a width, length and depth, said hasp having a profile corresponding to the side profile of a vending machine such that said hasp is positioned flush with the vending machine, leaving no gaps between said system and said vending machine.

5. The hasp cover of claim one (1) wherein said bolt head cover top unit and said bolt head cover base unit are welded to each other prior to use.

6. The hasp cover of claim one (1) wherein said bottom edge of said hasp cover top unit and said hasp cover bottom unit are permanently affixed to each other prior to use.

7. The hasp cover of claim one (1) further comprising a high-strength and distortion resistant material
